(19) United States
(12) Patent Application Publication
(10) Pub. No.: US 2011/0152156 A1
(43) Pub. Date: Jun. 23, 2011

(54) SOLID BLOCK ACID CONTAINING CLEANING COMPOSITION FOR CLEAN-IN-PLACE MILKING MACHINE CLEANING SYSTEM

(76) Inventors: Joachim Sauter, Dormagen (DE); Anna Burczek, Idstein (DE); Ludger Grunwald, Wuppertal (DE); Karl Helminger, Ainring (DE); Hubert De Roquefeuil, Montford Lamaury (FR); Ralf Schuster, Rosenheim (DE)

(21) Appl. No.: 12/739,451

(22) PCT Filed: Nov. 5, 2007
(86) PCT No.: PCT/EP2007/061858

§ 371 Date: Nov. 5, 2010

(51) Int. Cl. C11D 3/60

(52) U.S. Cl. 510/234

(57) ABSTRACT

The invention relates to solid block acid containing cleaning compositions comprising based on the composition A) 10-75 wt-% of at least one liquid mineral acid selected from the group consisting of phosphoric acid, sulphuric acid, sulphurous acid, and nitric acid, B) 1-60 wt-% of at least one solid organic acid with pKa at 20° C. between 1.0 and 1.1, C) 15-80 wt-% of at least one carboxylic acid selected from the group consisting of citric acid monohydrate, hydroxyacetic acid, maleic acid, succinic acid, glutaric acid and adipinic acid, D) 5-40 wt-% urea, E) 0.1-10 wt-% of at least one non-ionic surfactant, and the rest up to 100 wt-% is water, wherein the composition contains less than 1 wt-% nonylphenol ethoxylates and halogen compounds.

### FIELD OF THE INVENTION

The invention relates to improved acid containing solid block cleaning compositions that can be used to remove food soil from typically food or foodstuff related manufacturing equipment or processing surfaces. The invention also relates to the use of said compositions in clean-in-place milking machine cleaning systems. Further, the invention relates to cleaning concentrates and use-solutions obtainable from said compositions.

### BACKGROUND OF THE INVENTION

Periodic cleaning and sanitizing in the food process industry is a regimen mandated by law and rigorously practiced to maintain the exceptionally high standards of food hygiene and shelf-life expected by today's consumer. Residual food soil, left on food contact equipment surfaces for prolonged periods, can harbor and nourish growth of opportunistic pathogen and food spoilage microorganisms that can contaminate foodstuffs processed in close proximity to the residual soil.

Insuring protection of the consumer against potential health hazards associated with food borne pathogens and toxins and maintaining the flavor, nutritional value and quality of the foodstuff requires diligent cleaning and soil removal from any surfaces of which contact the food product directly or are associated with the processing environment.

The term “cleaning” in the context of the care and maintenance of food preparation surfaces and equipment refers to the treatment given all food product

contact surfaces following each period of operation to substantially remove food soil residues including any residue that can harbor or nourish any harmful microorganism. Freedom from such residues, however, does not indicate perfectly
clean equipment. Large populations of microorganisms may exist on food process
surfaces even after visually successful cleaning. The concept of cleanliness as applied in the food process plant is a continuum wherein absolute cleanliness is the ideal goal always strived for; but, in practice, the cleanliness achieved is of lesser degree.

The technology of cleaning in the food process industry has traditionally been empirical. The need for cleaning treatments existed before a fundamental understanding of soil deposition and removal mechanism was developed. Because of food quality and public health pressures, the food processing industry has attained a high standard of practical cleanliness and sanitation. This has not been achieved without great expense, and there is considerable interest in more efficient and less costly technology. As knowledge about soils, the function of cleaning chemicals, and the effects of cleaning procedures increased and, as improvements in plant design and food processing equipment became evident, the cost effectiveness and capability of cleaning treatments, i.e. cleaning products and procedures, to remove final traces of residue have methodically improved. The consequence for the food process industry and for the public is progressively higher standards.

The food process industry has come to rely more on detergent efficiency to compensate for design or operational deficiencies in their cleaning programs.

This is not to suggest that the industry has not addressed these factors; indeed, cleaning processes have changed considerably during recent years because of technological advances in food processing equipment and development of specialized cleaning equipment. Modern food processing industries have revolutionized their clean-up procedures through cleaning-in-place (CIP) and automation.

Clean-in-place (CIP) systems are generally found in industries which produce fluidized ingestible products for humans or animals such as the dairy industry, the pharmaceutical industry, and the food industry. Clean-in-place systems are generally regarded as large production plant systems having reservoirs, pipes, pumps and mixing vessels which cannot be broken down to be cleaned. Additionally, clean-in-place preparation systems often require high sanitization when used in the production of ingestible substances.

A typical CIP sequence may consist of the following five stages (see “Hygiene for Management” by R. A. Sprenger, 5th Edition, p. 135):

1. Pre-rinse with cold water to remove gross soil
2. Detergent circulation to remove residual adhering debris and scale
3. Intermediate rinse with cold water to remove all traces of detergent
4. Disinfectant circulation to destroy remaining microorganisms and
5. Final rinse with cold water to remove all traces of disinfectants.

Foam is a major concern in these highly agitated, pump recirculation systems during the cleaning program. Excessive foam reduces flow rate, cavitates recirculation pumps, inhibits detersive solution contact with soiled surfaces, and prolongs drainage. Such occurrences during CIP operations adversely affect cleaning performance.

Low foaming is therefore a descriptive detergent characteristic broadly defined as a quantity of foam which does not manifest any of the problems enumerated above when the detergent is incorporated into the cleaning program of a CIP system. Because no foam is the ideal, the issue becomes that of determining what is the maximum level or quantity of foam which can be tolerated within the CIP system without causing observable mechanical or detersive disruption and then commercializing only formulas having foam profiles at least below this maximum but, more practically, significantly below this maximum for assurance of optimum detersive performance and CIP system operation.

A major challenge of detergent development for the food process industry is the successful removal of soils that are resistant to conventional treatment and the elimination of chemicals that are not compatible with food processing. One such soil is protein, and one such group of chemicals are halogens or halogen yielding compounds, which can be incorporated into detergent compounds or added separately to cleaning programs for protein removal.

Protein soil residues, often called protein films, occur in all food processing industries but the problem is greatest for the dairy industry, including milk and milk products producers, because dairy products are among the most perishable of major foodstuffs and any soil residues have serious quality consequences. That protein soil residues are common in the fluid milk and milk by-products industry, including dairy farms, is no surprise because protein constitutes approximately 27% of natural milk solids, (“Milk Components and Their Characteristics”, Harper, W. J., in Diary Technology and Engineering (editors Harper. W. J. and Hall, C. W.), p. 18-19, The AVI Publishing Company, Westport, 1976).

Because biological fluids such as milk are complex mixtures, the kinetics of the protein adsorption process are confused by concurrent events occurring at interfacial surfaces within the bulk solution and at the equipment surfaces. Temperature, pH, protein populations and concentrations, and presence of other inorganic and organic moieties have effect on rate dynamics. However, there is general agreement that protein adsorption is rapid, reversible, and randomly arranged at fractional surface coverages less than 50% and the rate is mass transport controlled, i.e. all adsorption and desorption processes depend on transport of bulk solute to and from the interface. As coverage exceeds 50%, surface ordering develops, and given sufficient contact time, adsorbed proteins undergo conformational and orientational changes to optimize interfacial interactions and system stability. Proteins less optimally adsorbed undergo desorption or exchange by larger proteins having more binding sites. The process rate becomes surface reaction limited (mass action controlled). With increasing residence time, protein adsorption becomes irreversible.

Chlorine degrades protein by oxidative cleavage and hydrolysis of the peptide bond, which breaks apart large protein molecules into smaller peptide chains. The conformational structure of the protein disintegrates, dramatically lowering the binding energies, and effecting desorption from the surface, followed by solubilization or suspension into the cleaning solution.

The use of chlorinated detergent solutions in the food process industry is not without problems. Corrosion is a constant concern, as is degradation of polymeric gaskets, hoses, and appliances. Practice indicates that available chlorine concentrations must initially be at least 75 ppm and preferably 100 ppm for optimum protein film removal. At concentrations of available chlorine less than 50 ppm, protein soil build-up is enhanced by formation of insoluble, adhesive chloro-proteins (see “Cleanability of Milk-Filmed Stainless Steel by Chlorinated Detergent Solutions”, Jensen, J. M., Journal of Dairy Science, Vol. 53, No. 2, pp. 248-251 (1970).

Chlorine concentrations are not easy to maintain or analytically discern in detersive solutions. The dissipation of available chlorine by soil residues has been well established and chlorine can form unstable chloramino derivatives with proteins which titrate as available chlorine. The effectiveness of chlorine on protein soil removal diminishes as solution temperature and pH decrease: lower temperatures affecting reaction rate, and lower pH favoring chlorinated additional moieties.

These problems associated with the use and applications of chlorine release agents in the food process industry have been known and tolerated for decades. Chlorine has improved cleaning efficiency, and improved sanitation resulting in improved product quality. No safe and effective, lower cost alternative has been advanced by the detergent manufacturers.

However, a new issue forces change upon both the food process industry and the detergent manufacturers: the growing public concern over the health and environmental impacts of halogens and organohalogens. Whatever the merits of the scientific evidence regarding carcinogenicity, there is little argument that organohalogen compounds are persistent and bioaccumulative and that many of these compounds pose greater non-cancer health effects (endocrine, immune, and neurological problems) principally in the offspring of exposed humans and wildlife, at extremely low exposure levels. It is, therefore, prudent for the food process industry and their detergent suppliers to refocus on finding alternatives to the use of halogen containing release agents in cleaning compositions. A substantial need exists for a non-halogen protein film stripping agent for detergent compositions having applications in the food process industry and having the versatility to remedy the problems heretofore described and presently unresolved.

Hard surface cleaners useful in institutional and non-institutional environments may take any number of forms. Typically these cleaners are liquid formulations as either a non-aqueous, organic cleaner formulation, or aqueous cleaner formulations that can be neutral, acidic or alkaline in pH when diluted to use solutions. Organic cleaner formulations are commonly prepared in an organic base material such as a solvent or surfactant base. Further these formulations may comprise a variety of ingredients such as sequestrants, rust inhibitors, etc.

Aqueous, neutral, acid, or alkaline cleaners, in use solution concentrations, are typically formulated, using a major proportion of an aqueous diluent and minor, but effective amounts of surfactants, co-solvents and sequestrants. In large part, these cleaners can be used in the form of an aqueous liquid concentrate that is diluted with water to form the use solution. These dilute liquid cleaning formulations have been useful in a number of cleaning environments. However, dilute liquid cleaning formulations that contain a substantial proportion of an aqueous or organic diluent often entails large transportation costs to move solvent or water. Further, cleaning concentrates in liquid form can often be contaminated or can in some cases deteriorate, phase separate and become useless. Further, liquid materials can spill, splash or otherwise be misused resulting in a safety hazard in contact between users and the alkaline or acid concentrate materials.

While liquid aqueous cleaners have had success in removing soil from a variety of hard surfaces, the aqueous liquid materials still pose a substantial drawback to a user based on both economic and safety considerations. Accordingly, a substantial need exists in providing solid cleaners being efficient, more cost effective and safe.

U.S. Pat. No. 5,310,549 discloses solid concentrate iodine cleaning compositions for application in food manufacturing and processing plants, especially in clean-in-place systems of the dairy industry, comprising an iodine source and a complexing agent, a solidifier, and optionally an acidulant. Iodine sources are iodine complexes which, being organohalogen compounds, also might be persistent and bioaccumulative in human bodies. The concentrate composition provides a use-solution having variable levels of foaming depending on the iodine/complexing agent ratio. The compositions rely on nonylphenol ethoxylates having an ethoxylate molar value ranging from about 6 moles to 15 moles for reasons of low foaming character and complexing stability provided to the composition. However, nonylphenol ethoxylates are more and more abandoned because of their negative health effects. The concentrate iodine composition contains additional ingredients as necessary to assist in defoaming. Defoamers which have been found useful include fatty acids such as coconut fatty acid, fatty alcohols, and phosphate esters. These defoamers are present at a concentration range preferably from about 0.05 wt-% to 0.5 wt-%, and most preferably from about 0.10 wt-% to about 0.50 wt-%.

U.S. Pat. No. 6,432,906 discloses solid block acid cleaners for application to hard surfaces in general comprising a solid matrix including a blend of an acid cleaner component, a surfactant cleaner composition from the group consisting of an anionic surfactant, a non-ionic surfactant or mixtures thereof, and a binding agent or solidifying compound. Again, preferred non-ionic surfactants included in all working examples given in the specification are nonylphenol ethoxylates.

### SUMMARY OF THE INVENTION

The objectives of this product invention are thus to provide an acid containing cleaning composition that is harmless from an environmental and sanitary point of view, that can be formed into a stable solid block, that produces only a minimum of foam suitable for application in CIP systems, and that shows excellent cleaning properties.

The technical object of the invention is solved by solid block acid containing cleaning composition comprising based on the composition A) 10-75 wt-%, preferably 20-50 wt-%, and most preferably 25-30 wt-%, of at least one liquid mineral acid selected from the group consisting of phosphoric acid, sulphuric acid, sulphurous acid and nitric acid, preferably phosphoric acid, B) 1-60 wt-%, preferably 5-20 wt-%, and most preferably 7-16 wt-%, of at least one solid organic acid with pKa at 20° C. between 1.0 and 1.1, preferably sulfamic acid, C) 15-80 wt-%, preferably 20-40 wt-%, and most preferably 25-35 wt-%, of at least one carboxylic acid selected from the group consisting of citric acid monohydrate, hydroxyacetic acid, maleic acid, succinic acid, glutaric acid and adipinic acid, preferably citric acid monohydrate, D) 5-40 wt-%, preferably 10-20 wt-%, and most preferably 14-15 wt-% urea, E) 0.1-10 wt-%, preferably 0.5-5 wt-%, and most preferably 1-2 wt-%, of at least one non-ionic surfactant, preferably selected from the group consisting of alcohol ethoxylates, alcohol alkoxylates, ethylene oxide/propylene oxide copolymers, fatty amine ethoxylates, fatty acid ester derivatives, and amine oxides, and the rest up to 100 wt-% is water, wherein the composition contains less than 1 wt-%, preferably less than 0.1 wt-%, and most preferably less than 0.01 wt-% nonylphenol ethoxylates and halogen compounds.

The invention also includes methods of use for the composition of the invention. The solid composition can be dispensed from the solid state to form an aqueous concentrate. The concentrate has a ratio of cleaning composition to water of from 1:50 to 1:100. Such concentrate material can be further diluted with water to form a use-solution. The use-solution has a ratio of cleaning-composition to water of from 1:50 to 1:10000, preferably from 1:100 to 1:2000. Alternatively the use solution can also be produced directly by desolving the solid block with the necessary amount of water. Such use-solutions can be applied to a variety of hard surfaces in the institutional or industrial markets for removal of a variety of soil types. They are especially useful for application in clean-in-place (CIP) cleaning systems within food process facilities and especially for dairy farm and fluid milk and milk by-product producers. The acid containing solid block can also be used in larger diary plants within an automatic processing system for cleaning, i.e. in an automatic CIP cleaning system.

Diary systems are cleaned with alternating acidic and alkaline cleaning steps. The alkaline step is used to remove fat and proteins from the system and the acidic step is used to remove hard water residues or Calcium salt residues. The solid block according to the invention can be used in such a system with alternating acidic and alkaline cleaning steps. In such a process the diary system is cleaned with the acidic composition prepared from the acidic block until the block is completely desolved. After that an alkaline solid block can be used in the same equipment to prepare the alkaline cleaning solution which is used for the alkaline cleaning step.

### DETAILED DESCRIPTION OF THE INVENTION

Surprisingly it was found that a solid block acid containing cleaning composition that is harmless from an environmental and sanitary point of view, that can be formed into a stable solid block, that produces only a minimum of foam suitable for application in CIP systems, and that shows excellent cleaning properties can be achieved without the use of any halogen and organohalogen compounds as well as any alkylphenol ethoxylates.

The formulated acidic material solidifies through the interaction of the intentionally blended components and can be solidified within a disposable container, a film, a water soluble wrapping material or can be packaged in other convenient packaging material. For the purpose of the materials used in making the acid cleaner of the invention and the acid cleaner of the invention, a “solid” is a composition that, at use temperature, is sufficiently resistant to flow that the unsupported composition will not substantially change shape upon standing. Such a solid can be in the form of a hard block or brick or a deformable but rigid aqueous dispersion or hard gel. For the purposes of this invention, a liquid is a material that flows at a substantial rate, at use temperature, such that the unsupported material (removed from a container) will lose its shape upon standing in less than one minute.

The composition of the invention generally comprises a non-ionic surfactant. Surfactants function to alter surface tension in the resulting compositions, assist in soil removal and suspension by emulsifying soil and allowing removal through a subsequent flushing or rinse.

Non-ionic Surfactants, edited by Schick, M. J., Vol. 1 of the Surfactant Science Series, Marcel Dekker, Inc., New York, 1983 is an excellent reference on the wide variety of non-ionic compounds generally employed in the practice of the present invention. Non-ionic surfactants useful in the invention are generally characterized by the presence of an organic hydrophobic group and an organic hydrophilic group and are typically produced by the condensation of an organic aliphatic or polyoxyalkylene hydrophobic compound with a hydrophilic alkaline oxide moiety which in common practice is ethylene oxide or a polyhydration product thereof, polyethylene glycol.

Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a non-ionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful non-ionic surfactants in the present invention include:

1. Block polyoxypropylene-polyoxyethylene polymeric compounds based upon propylene glycol, ethylene glycol, glycol, trimethylolpropane, and ethylenediamine as the initiator reactive hydrogen compound. Examples of polymeric compounds made from a sequential propoxylation and ethoxylation of initiator are commercially available under the trade name Pluronic and Tetronic manufactured by BASF Corp.

Pluronic compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1.000 to about 4.000. Ethylene oxide is then added to sandwich this hydrophobe between hydrophilic groups, controlled by length to constitute from about 10% by weight to about 80% by weight of the final molecule.

Tetronic compounds are tetra-functional block copolymers derived from the sequential addition of propylene oxide and ethylene oxide to ethylenediamine. The molecular weight of the propylene oxide hydrotype ranges from about 500 to about 7,000 and the hydrophile, ethylene oxide, is added to constitute from about 10% by weight to about 80% by weight of the molecule.

2. Condensation products of one mole of a saturated or unsaturated, straight or branched chain alcohol having from about 6 to about 24 carbon atoms or a primary or secondary fatty amine with from about 3 to about 50 moles of ethylene oxide and/or propylene oxide. The alcohol moiety can consist of mixtures of alcohols in the above delineated carbon range or it can consist of an alcohol having a specific number of carbon atoms within this range. Examples of commercial surfactant are available under the trade name Noedol manufactured by Shell Chemical Co. and Alfonic manufactured by Vista Chemical Co.

3. Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade name Nopalcol manufactured by Henkel Corporation and Lipopeg manufactured by Lipo Chemicals Inc.

In addition to ethoxylated carboxylic acids, commonly called polyethylene glycol esters, other alkanoic acid esters formed by reaction with glycerides, glycerine and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances.

Low foaming alkoxylated non-ionics are preferred although other higher foaming alkoxylated non-ionics can be used without departing from the spirit of this invention if used in conjunction with low foaming non-ionics so as to control the foam profile of the mixture within the detergent composition as a whole. Foaming properties may be evaluated according to the method described in the examples. Examples of non-ionic low foaming surfactants include:

4. Compounds from (1.) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1.000 to about 3.100 with the central hydrophile comprising 10% by weight to about 80% by weight of the final molecule. These reverse Pluronics are manufactured by BASF Corporation under the trade name Pluronic R surfactants.

Likewise, the Tetraonic R surfactants are produced by BASF Corporation by the sequential addition of ethylene oxide and propylene oxide to ethylenediamine. The hydrophobic portion of the molecule weighs from about 2,100 to about 6,700 with the central hydrophile comprising 10% by weight to 80% by weight of the final molecule.

5. Compounds from groups (1.), (2.), and (3.) which are modified by “capping” or “end blocking” the terminal hydroxy group or groups (of multifunctional moieties) to reduce foaming by reaction with a small hydrophobic molecule such as propylene oxide or butylene oxide and short chain fatty acids or alcohols containing from 1 to about 5 carbon atoms and mixtures thereof. Such modifications to the terminal hydroxy group may lead to all-block, block-heteric, heteric-block or all-heteric non-ionics.

6. Useful water soluble amine oxide surfactants are selected from the coconut or tallow alkyl di-(lower alkyl) amine oxides, specific examples of which are dodecyldimethylamine oxide, tridecyldimethylamine oxide, tradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2hydroxydodecyl) amineoxide, and 3,6,9-trioctadecyldimethylamine oxide.

The non-ionic surfactants enumerated above can be used singly or in combination in the practice and utility of the present invention. The above examples are merely specific illustrations of the numerous surfactants which can find application within the scope of this invention.

Non-ionic surfactants which have generally been found to be particularly useful in the invention are those which comprise ethylene oxide moieties, propylene oxide moieties, as well as mixtures thereof. These non-ionics have been found to be pH stable in acidic environments, as well as providing the necessary cleaning and soil suspending efficacy. Non-ionic surfactants which are useful in the invention include polyoxyalkylene non-ionic surfactants such as C₈₋₂₂ normal fatty alcohol-ethylene oxides or propylene oxide condensates, (that is the condensation products of one mole of fatty alcohol containing 8-22 carbon atoms with from 2 to 20 moles of ethylene oxide or propylene oxide), polyoxypropylene-polyoxyethylene condensates having the formula HO(C2H4O)ₓ(C3H6O)_{y}H wherein (C2H4O)ₓ equals at least 15% of the polymer and (C3H6O)_{y} equals 20-90% of the total weight of the compound, alkylpolyoxypropylene-polyoxyethylene condensates having the formula RO—(C3H6O)ₓ(C2H4O)_{y}H where R is a C1-15 alkyl group and x and y each represent an integer of from 2 to 98, polyoxyalkylene glycols, and butyleneoxide capped alcohol ethoxylate having the formula R(OC2H4)_{y}(OC4H9)ₓOH where R is a C8-18 alkyl group and y is from about 3.5 to 10 and x is an integer from about 0.5 to 1.5.

The surfactant or surfactant system will comprise up to about 10% by weight of the total acid cleaning composition. Typically, the weight-percent surfactant will be in the range of about 0.1% to 10%, or more preferably, for improved cleaning efficacy, in the range of about 0.5% to 5% by weight, and most preferably in the range of about 1% to 2%.

The particular surfactant or surfactant mixture chosen for use in the process and products of this invention depends upon the conditions of final utility, including method of manufacture, physical product form, use-pH, use-temperature, foam control, and soil type.

In practice the present invention permits incorporation of high concentrations of surfactant as compared to conventional chlorinated, high alkaline CIP cleaners. Certain preferred surfactant or surfactant mixtures of the invention are not generally physically compatible nor chemically stable with the alkalis and chlorine of convention. This major differentiation from the art necessitates not only careful foam profile analysis of surfactants being included into compositions of the invention but also demands critical scrutiny of their detersive properties of soil removal and suspension. The present invention relies upon the surfactant system for gross soil removal from equipment surfaces and for soil suspension in the detersive solution. Soil suspension is as important a surfactant property in CIP detersive systems as soil removal to prevent soil redeposition on cleaned surfaces during recirculation and later re-use in CIP systems which save and re-employ the same detersive solution again for several cleaning cycles.

A solidifying agent is used in the claimed invention in order to convert the liquid detergent premix into a solid. Urea, NH2CONH2, has been found to be especially useful in the composition of the present invention as a solidifying agent to bind both the acidulant and surfactant composition to provide an aqueous soluble, dispensable solid block.

The solid block cleaning composition can comprise about 5 to 40 wt % urea. We have found that the preferred compositions, for reasons of economy, desired hardness and solubility, comprise about 10% to 20% by weight urea. Most preferably, the compositions generally comprise about 14% to 15% by weight urea. Here again, varying the concentration of the urea solidifier within the present composition will vary the physical chemical characteristics of the composition. Accordingly, increasing the concentration of the urea hardener in the present composition will generally tend to increase the hardness of the solid composition. In sharp contrast, decreasing the concentration of solidifying agent will tend to loosen or soften the concentrate composition.

Urea may be obtained from a variety of chemical suppliers. Typically, urea will be available in prilled form, and any industrial grade urea may be used in the context of this invention.

The solid block cleaning composition of the present invention also contains an acidulant or acid source. The acidulant functions to reduce the pH of the composition. Also, to the extent that it is present, the acidulant functions to facilitate removal of salt build-up in pipelines and other application surfaces exposed to the composition.

In accordance with the present invention, the acidulant source used in the solid block cleaning composition will comprise a combination of at least one liquid mineral acid source, at least one solid organic acid source with pKa at 20° C. between 1.0 and 1.1, and at least one carboxylic acid source. The concentration of the acids as a percentage of the entire composition will generally vary from about 25 to 95% by weight, preferably from about 65 to 90% by weight, and most preferably from about 70 to 85% by weight. Of this composition, about 1 to 60% by weight, preferably about 5 to 20% by weight, and most preferably about 7 to 16% by weight, comprise at least one solid acid with pKa at 20° C. between 1.0 and 1.1, about 15 to 80% by weight, preferably about 20 to 40% by weight, and most preferably about 25 to 35% by weight comprise at least one carboxylic acid source, and about 10 to 75% by weight, preferably about 20 to 50% by weight, and most preferably about 25 to 30% by weight comprise at least one liquid mineral acid source.

Here again, varying the concentrations of acidulants within the composition of the present invention will alter the chemical characteristics of the resulting composition. Specifically, increasing the concentration of an acidulant past a certain point may create a system which is corrosive to tanks and pipes.

Further, we have found that a combination of 5 wt % to 20 wt %, preferably 7 wt (Y0 to 16 wt %, of a solid acid with pKa at 20° C. between 1.0 and 1.1, preferably sulfamic acid, combined with 20 wt % to 50 wt %, preferably 25 wt % to 30 wt %, of a liquid mineral acid source, preferably phosphoric acid, and 20 wt % to 40 wt %, preferably 25 wt % to 35 wt %, of a carboxylic acid, preferably citric acid monohydrate, provides the most preferred solid block acid containing cleaning composition.

Carboxylic acids useful in accordance with the invention include hydroxyacetic (glycolic) acid, maleic acid, succinic acid, glutaric acid, and adipic acid. Any combination of these organic acids may also be used.

Liquid mineral acids useful in accordance with the invention include phosphoric acid, sulphuric acid, sulphurous acid, and nitric acid. These acids may also be used in combination.

As solid organic acid with pKa at 20° C. between 1.0 and 1.1 sulfamic acid is useful

Especially useful in the present composition is a combination of phosphoric acid, citric acid monohydrate, and sulfamic acid.

The invention will be further described in the following examples which are only meant to exemplify the present invention without restricting its scope.

### EXAMPLES

### 1. Foam Behaviour

The following test was performed to elaborate the foam behaviour.

50 ml of the composition to be tested is filled into a 250 ml measuring cylinder and closed with a stopper. The measuring cylinder is placed in a rotating device. The rotating device is started and the cylinder is rotated around its axis for 200 times. After that the rotating generator stops automatically. Immediately after stopping and again after 10 and 30 seconds the amount of produced foam is read off from the ml-scale on the cylinder. The initially filled in product of 50 ml is subtracted from the total foam volume.

At least 4 cylinders per composition are used for the test. The amount of foam produced within each cylinder is noted and compared with the average of each composition. Additionally it has to be compared how quick the foam breaks down.

The less foam builds up and the quicker the foam breaks down the better is the defoaming ability of the composition which is an important characteristic of a cleaner for automatic cleaning.

The following table 1 shows all ingredients of the compositions which were tested in the following examples. All concentrations in the table are given in weight percent. Example 1 is a composition according to the invention. Comparative example 2 is also used for automatic cleaning. For the foam test, use-solutions (0.2 wt-% of the respective composition in water) were prepared. Table 2 shows the results of the foam test.

TABLE 1
Compositions

| | | Comparative |
|---|---|---|
| Raw materials | Example 1 | example 2 |
| phosphoric acid, 75% | 36 | 36.5 |
| citric acid monohydrate | 33 | 41.5 |
| sulfamic acid | 17 | 9 |
| urea | 13 | 12.965 |
| fatty alcohol alkoxylate | 1 | |
| nonyl phenol ethoxylate | | 2.5 |
| polyoxyethyl polyoxypropyl | | 1 |
| block polymer | | |
| silicone defoamer | | 0.03 |
| dye | | 0.005 |

| | |
|---|---|
| water | ad 100 |

TABLE 2

| Foam Height [ml] | | |
|---|---|---|
| 0 sec | 10 sec | 30 sec |

Results of Foam Test at 20° C.

| | | | |
|---|---|---|---|
| Example 1 | 5 | 3 | 0 |
| Comparative | | | |
| example 2 | 50 | 10 | 0 |

Results of Foam Test at 50° C.

| | | | |
|---|---|---|---|
| Example 1 | 10 | 0 | 0 |
| Comparative | 10 | 5 | 4 |
| example 2 | | | |

It can be seen that the foam behaviour of the composition according to the invention in example 1 is by far better compared to the foam behaviour of the composition according to the state of the art (comparative example 2), although the latter contains a silicone defoamer. Furthermore it is an advantage that the foam of the composition according to the invention breaks down after a very short time compared to the composition according to the state of the art. As a result the composition according to the invention is better suitable for automatic cleaning.

### 2. Cleaning Behaviour

The following test was performed to elaborate the cleaning effectiveness.

Plates of stainless steel (5×10 cm) were prepared for the test by applying 0.1 to 0.2 g of standard soiling on one side of the test plate and subsequently allowing the deposited material to dry for 24 hours at 25° C. A mixture from grease and protein was used as standard soiling.

The cleaning test was effected by immersing the specimens thus prepared in 900 ml of the cleaning composition being present in a 1000 ml-beaker in a fully automatic dipping apparatus at a temperature of 40° C. for 20 minutes. The removal of the deposited material was determined using gravimetry.

By diluting with hard water to the concentration of use (0.2 wt-%), the compositions specified in table 1 were converted into use-solutions, the cleaning performance of which was determined by testing. Table 3 shows the results of the cleaning test.

TABLE 3
Results of Cleaning Test

| | | Clean plate + | | | | |
|---|---|---|---|---|---|---|
| Cleaning | Clean plate | total soil | Total soil | Plate after | Removed soil | Cleaning efficacy |
| composition | [g] | before [g] | before [g] | [g] | [g] | [%] |
| Example 1 | 39.082 | 39.269 | 0.187 | 39.137 | 0.132 | 70.8 |
| Comparative | 38.484 | 38.651 | 0.166 | 38.559 | 0.091 | 55.0 |
| Example 2 | | | | | | |

It can be seen that the cleaning efficacy of the composition according to the invention is by far better than the cleaning efficacy of the composition according to the state of the art.

1. A solid block acid containing cleaning composition comprising based on the composition
A) 10-75 wt-% of at least one liquid mineral acid selected from the group consisting of phosphoric acid, sulphuric acid, sulphurous acid, and nitric acid
B) 1-60 wt-% of at least one solid organic acid with pKa at 20° C. between 1.0 and 1.1
C) 15-80 wt-% of at least one carboxylic acid selected from the group consisting of citric acid monohydrate, hydroxyacetic acid, maleic acid, succinic acid, glutaric acid and adipinic acid
D) 5-40 wt-% urea
E) 0.1-10 wt-% of at least one non-ionic surfactant
and the rest up to 100 wt-% is water,
wherein the composition contains less than 1 wt-% nonylphenol ethoxylates and halogen compounds.

2. A composition according to claim 1 wherein the composition comprises based on the whole composition
A) 20-50 wt-% of at least one liquid mineral acid selected from the group consisting of phosphoric acid, sulphuric acid, sulphurous acid, and nitric acid
B) 5-20 wt-% of at least one solid organic acid with pKa at 20° C. between 1.0 and 1.1
C) 20-40 wt-% of at least one carboxylic acid selected from the group consisting of citric acid monohydrate, hydroxyacetic acid, maleic acid, succinic acid, glutaric acid, adipinic acid
D) 10-20 wt-% urea
E) 0.5-5 wt-% of at least one non-ionic surfactant
and the rest up to 100 wt-% is water.

3. A composition according to claim 1 or 2 wherein the composition comprises based on the whole composition
A) 20-50 wt-% phosphoric acid
B) 5-20 wt-% sulfamic acid
C) 20-40 wt-% citric acid monohydrate
D) 10-20 wt-% urea
E) 0.5-5 wt-% of at least one non-ionic surfactant
and the rest up to 100 wt-% is water.

4. A composition according to claim 1 wherein the composition comprises based on the whole composition
A) 25-30 wt-% phosphoric acid
B) 7-16 wt-% sulfamic acid
C) 25-35 wt-% citric acid monohydrate
D) 14-15 wt-% urea
E) 1-2 wt-% of at least one non-ionic surfactant
and the rest up to 100 wt-% is water.

5. A composition according to claim 1 wherein the non-ionic surfactant is selected from the group consisting of alcohol ethoxylates, alcohol alkoxylates, ethylene oxide/propylene oxide copolymers, fatty amine ethoxylates, fatty acid ester derivatives, amine oxides.

6. A composition according to claim 1 wherein the composition is held within a disposable container, a film or a water soluble wrapping material.

7. A concentrate comprising a composition according to claim 1 and water in a ratio from 1:50 to 1:100.

8. A use-solution comprising a composition according to claim 1 and water in a ratio from 1:50 to 1:10000.

9. A method of using a solid block acid containing cleaning composition according to claim 1 for cleaning milking machines comprising the step of positioning the composition in a dispenser, dissolving the composition in an aqueous diluent to obtain a concentrate, diluting the concentrate with an aqueous diluent to obtain a use-solution and applying said use-solution to the milking machine to remove the soil of the soiled surfaces.

10. A method according to claim 9 wherein the composition is positioned proximate a water spray means and is dispensed by contacting it with an aqueous spray to form a concentrate.
